(19) United States
(12) Patent Application Publication
(10) Pub. No.: US 2007/0128445 A1
(43) Pub. Date: Jun. 7, 2007

(54) METHOD OF MAKING AND INSPECTING AN IN MOLD COATED ARTICLE

(75) Inventors: Nelson E. Williams, Saline, MI (US); Joseph T. Donatti, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/275,040

(22) Filed: Dec. 5, 2005

(51) Int. Cl. B32B 27/40

(52) U.S. Cl. 428/423.1; 264/408; 264/255

(57) ABSTRACT

A method of making an article is disclosed in which an in-mold coating is applied to a mold over with a polyurethane forming mixture is applied. A fluorescent dye is mixed with a polyurethane forming mixture to form an ultraviolet enhanced mixture. After forming, the coated article is exposed to a source of ultraviolet light and inspected to identify areas not covered by the in-mold coating. An article of manufacture is disclosed that includes a polyurethane layer having fluorescent dye and an in-mold coating applied to the polyurethane layer. An interior trim part for a vehicle made according to the process is also disclosed.

### BACKGROUND OF THE INVENTION

1. Field of the Invention

The present invention relates to a method of making and inspecting an in-mold coated article.

2. Background Art

Techniques for manufacturing molded articles with painted, or coated, surfaces have been developed in which the paint, or coating, is applied to a mold surface prior to molding the article. A polymeric resin is supplied to the mold, the molded article cures, and bonds to the in-mold coating. This coating application process is commonly referred to as an in-mold coating process.

Manufacturing high quality parts, such as automotive interior components, may require assurance of complete in-mold coating coverage. If the molded substrate is colored to match the color of the in-mold coating, it is difficult to confirm the integrity of the in-mold coating coverage. It is easier to detect voids or gaps in the in-mold coating when the molded substrate that is applied over the in-mold coating is of a different color than the in-mold coating. If the in-mold coating and underlying substrate are of contrasting color, a simple visual inspection is all that is required to detect gaps or voids in the in-mold coating.

A color matched substrate may be used to improve color match and reduce the amount of in-mold coating required to manufacture parts that are of the desired color. It is difficult to detect unpainted areas on articles that are made of a color matched polymer that matches the in-mold coating. Color matching the substrate to the in-mold coating also assures long-term performance. Even if the substrate is color matched to the in-mold coating, it is important to achieve a complete coating with the in-mold coating to assure adequate performance in long term exposure testing without fading or color changes occurring either in the in-mold coating or the molded substrate.

There is a need for a simple and cost effective method for detecting areas on an article having an in-mold coating applied to the surface when the underlying molded substrate and the in-mold coating are color-matched.

Applicants' invention addresses the above problems and needs as summarized below.

### SUMMARY OF THE INVENTION

According to one aspect of the present invention, a method of making an article is provided in which an in-mold coating is applied to a mold. A fluorescent dye is mixed with a polymeric forming mixture to form an ultraviolet enhanced mixture. The ultraviolet enhanced mixture is sprayed over the in-mold coating and then cured to form a coated article. The coated article may then be exposed to a source of ultraviolet light and inspected to identify the areas on the coated article that are not covered by the in-mold coating.

According to other aspects of the method of the present invention, the step of applying the in-mold coating may be performed by spraying the mold with the in-mold coating. A polymer composition such as a polyurethane mixture may be compounded as a mixture of polyol and isocyanate. The polyurethane mixture may further comprise a pigment that colors the polyurethane mixture to match the in-mold coating color.

According to another aspect of the method of the present invention, the article made by the method may be a vehicle interior trim part.

According to other aspects of the method of the present invention, the step of mixing the fluorescent dye may be performed by injecting the dye into a spraying system of polyol, isocyanate and a color pigment. The step of spraying the UV-enhanced mixture may be performed by a spray gun that has a mixing chamber for mixing the dye, polyol, isocyanate and a color pigment. The quantity of fluorescent dye added to the polyol component of the mixture may be in the amount of 0.025 to 0.2% by weight of the polyol.

According to another aspect of the present invention, an article manufacturer is provided that comprises a polyurethane layer having a fluorescent dye mixed into the layer. An in-mold coating is applied to the polyurethane layer in the mold. The coverage of the in-mold coating may be inspected by exposing the article to a source of ultraviolet light.

According to other aspects of the invention as they relate to the article of manufacture, the polyurethane mixture may be a mixture of polyol and isocyanate. The polyurethane mixture may further comprise a color pigment that colors the polyurethane mixture to match the in-mold coating color. The article made by the method may be a vehicle interior trim part.

According to another aspect of the invention, an interior trim part for a vehicle may be made according to a process wherein a fluorescent dye is mixed with a polyurethane forming mixture to form an ultraviolet enhanced mixture. An in-mold coating is first applied to the mold and then the ultraviolet enhanced mixture is sprayed over the in-mold coating. The ultraviolet enhanced mixture is cured to form a coated article and then may be exposed to a source of ultraviolet light that allows the coated article to be inspected to identify areas on the coated article that are not covered by the in-mold coating.

According to other aspects of the invention, the step of applying the in-mold coating may be performed by spraying the mold with an in-mold coating. The polyurethane mixture may comprise a mixture of polyol and isocyanate and further may comprise a color pigment that colors the polyurethane mixture to match the in-mold coating color. The step of mixing the fluorescent dye may be performed by injecting the dye into a spraying system with the polyol, isocyanate and a color pigment. A florescent dye may be added to the polyol in the amount of between 0.025 to 0.2% by weight of the polyol. A spray gun may be provided that has a mixing chamber for mixing the dye, polyol, isocyanate and a color pigment.

These and other aspects of the present invention will be better understood in view of the attached drawings and the following detailed description of the illustrated embodiment.

### BRIEF DESCRIPTION OF THE DRAWINGS

FIG. 1 is a diagrammatic view of a manufacturing process in which an in-mold coating is applied to a mold surface;

FIG. 2 is a diagrammatic view showing a molded article being formed in the mold by spraying a polymer including a fluorescent dye over the in-mold coating and the mold; and

FIG. 3 is a diagrammatic view showing a part made according to the process being inspected under a UV light source.

### DETAILED DESCRIPTION OF THE PREFERRED EMBODIMENT(S)

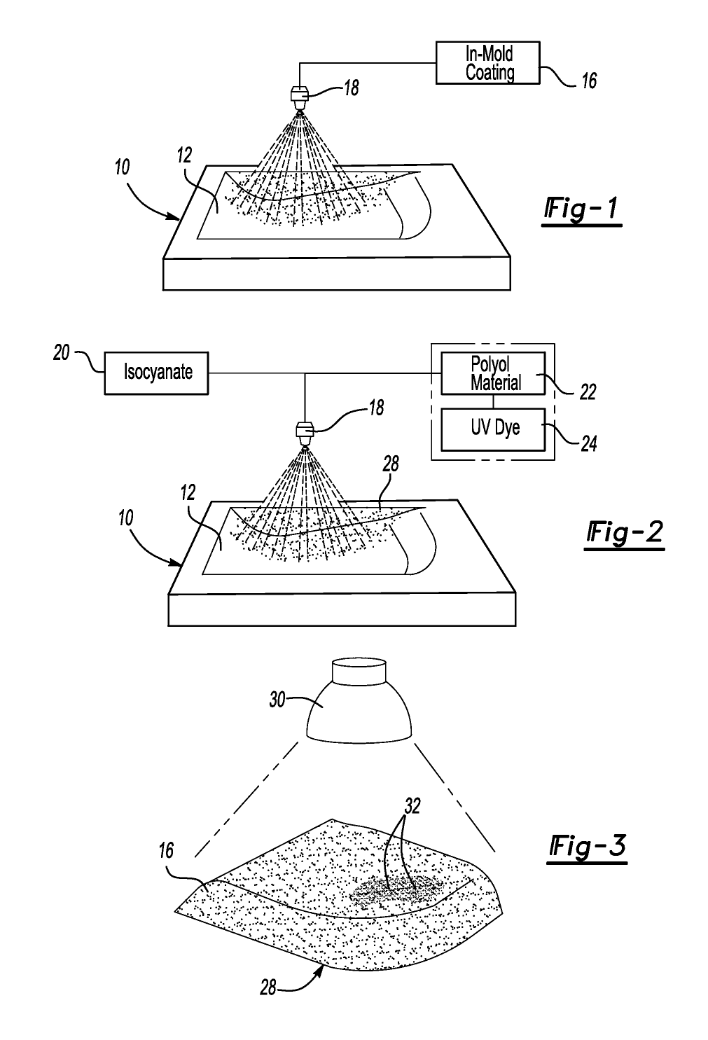

Referring to FIG. 1, a mold 10 is shown that defines a mold cavity 12. An in-mold coating 16 is applied by a spray applicator 18. The in-mold coating 16 is applied so that it completely coats the inside of the mold cavity 12. Prior to applying the in-mold coating, a mold release compound may be applied to the mold cavity 12 to facilitate the separation of the in-mold coating 16 from the mold cavity 12.

Referring to FIG. 2, the mold 10 including the mold cavity 12 is shown after it has been coated with the in-mold coating 16. To make a polyurethane article, a reactive mixture of isocyanate 20 and polyol 22 are sprayed into the mold. The polyol 22 may include an ultraviolet (UV) dye 24. Examples of UV dyes that may be added to the polyol 22 may include CIBA® UVITEX® OB; CIBA UVITEX OB-P; and CIBA UVITEX OB-ONE. The UVITEX products are high molecular weights optical brighteners that may be used as a fluorescent whitening agent in a wide variety of products. The of may be added to the polyol 22 in the amount of 0.1% by weight of the polyol. It is anticipated that the amount of UVITEX added to the polyol may range from between 0.025-2% by weight of the mixture of polyol.

A molded article 28 is formed by spraying, or otherwise applying the isocyanate 20, polyol 22 and UV dye are combined to form an ultraviolet enhanced mixture upon the surface of the mold cavity 12. A colorant may also be added to the polyol for color matching to the in-mold coating. When completed, the molded article 28 is removed from the mold cavity 12.

Referring to FIG. 3, the molded article 28 is shown inverted with the in-mold coating 16 facing upwardly toward a UV light source 30. The UV light source is selected depending upon the absorption and emission spectra of the UV dye. For UVITEX, the desired wavelengths for maximum fluorescence are between 374 and 375 nm and the desired UV light source is selected to maximize the fluorescence of the UV dye. The molded article 28 with the in-mold coating 16 applied to the surface as shown in FIG. 3 may be visually inspected to locate any voids 32 in the in-mold coating 16 that appear as gaps or holes that fluoresce.

Any voids 32 can subsequently be identified and corrected by applying additional in-mold coating or paint that is compatible with the in-mold coating to the portion of the molded article 28 with the voids 32. The in-mold spray process may also be reprogrammed to provide better coverage on subsequently manufactured articles. The isocyanate 20 and polyol 22 may also have a pigment or colorant added thereto to match the color of the substrate formed by the polyurethane forming component to the in-mold coating.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an article, comprising:
applying an in-mold coating to a mold;
mixing a florescent dye in a polymeric forming mixture to form an ultraviolet enhanced mixture;
spraying the ultraviolet enhanced mixture over the in-mold coating;
curing the ultraviolet enhanced mixture to form a coated article;
exposing the coated article to a source of ultraviolet light; and
inspecting the coated article to identify areas on the coated article that are not covered by the in-mold coating.

2. The method of claim 1 wherein the step of applying the in-mold coating is performed by spraying the mold with the in-mold coating.

3. The method of claim 1 wherein the polymeric mixture is a polyurethane mixture of polyol and isocyanate.

4. The method of claim 3 wherein the polyurethane mixture further comprises a color pigment that colors the polyurethane mixture to match the in-mold coating color.

5. The method of claim 1 wherein the article made by the method is a vehicle interior trim part.

6. The method of claim 1 wherein the step of mixing the florescent dye is performed by injecting the dye into a spraying system with polyol, isocyanate, and a color pigment.

7. The method of claim 6 wherein a spray gun is provided that has a mixing chamber for mixing the dye, polyol, isocyanate, and a color pigment.

8. The method of claim 6 wherein the florescent dye is added to the polyol in the amount of 0.025 to 0.2% by weight of the polyol.

9. An article of manufacture, comprising:
a polyurethane layer having a florescent dye mixed into the layer; and
an in-mold coating applied to the polyurethane layer, wherein the coverage of the in-mold coating may be inspected by exposing the article to a source of ultraviolet light.

10. The article of manufacture of claim 9 wherein the polyurethane mixture is a mixture of polyol and isocyanate.

11. The article of manufacture of claim 10 wherein the polyurethane mixture further comprises a color pigment that colors the polyurethane mixture to match the in-mold coating color.

12. The article of manufacture of claim 9 wherein the article made by the method is a vehicle interior trim part.

13. An interior trim part for a vehicle made according to a process comprising:
applying an in-mold coating to a mold;
mixing a florescent dye in a polyurethane forming mixture to form a ultraviolet enhanced mixture;
spraying the ultraviolet enhanced mixture over the in-mold coating;
curing the ultraviolet enhanced mixture to form a coated article;
exposing the coated article to a source of ultraviolet light; and
inspecting the coated article to identify areas on the coated article that are not covered by the in-mold coating.

14. The product of claim 13 wherein the step of applying the in-mold coating is performed by spraying the mold with the in-mold coating.

15. The product of claim 13 wherein the polyurethane mixture is a mixture of polyol and isocyanate.

16. The product of claim 15 wherein the polyurethane mixture further comprises a color pigment that colors the polyurethane mixture to match the in-mold coating color.

17. The product of claim 13 wherein the step of mixing the florescent dye is performed by injecting the dye into a spraying system with polyol, isocyanate, and a color pigment.

18. The product of claim 13 wherein the florescent dye is added to the polyol in the amount of 0.025 to 0.2% by weight of the polyol.

19. The product of claim 13 wherein the fluorescent dye is added to the polyol in the amount of 0.1% by weight of the polyol.

20. The product of claim 13 wherein a spray gun is provided that has a mixing chamber for mixing the dye, polyol, isocyanate, and a color pigment.
